(19) United States
(12) Patent Application Publication
(10) Pub. No.: US 2017/0050272 A1
(43) Pub. Date: Feb. 23, 2017

(54) Elongate Weld And A Beam Having Such A Weld

(71) Applicant: Gestamp Hardtech AB, Lulea (SE)

(72) Inventors: Martin Holmberg, Lulea (SE); Mattias Lundman, Ojebyn (SE)

(73) Assignee: Gestamp Hardtech AB, Lulea (SE)

(21) Appl. No.: 15/118,550

(22) PCT Filed: Jan. 16, 2015
(86) PCT No.: PCT/SE2015/050037

§ 371 Date: Aug. 12, 2016

(30) Foreign Application Priority Data
Feb. 17, 2014 (SE) SE 1400087-1

(51) Int. Cl. B23K 31/02; B62D 25/04; B62D 21/15

(52) U.S. Cl. CPC B23K 31/022; B62D 21/157; B62D 25/04; B23K 2201/006

(57) ABSTRACT

A hat profile (11) has a tensile strength exceeding 1400 MPa and it has soft bands (20) with a tensile strength below 1100 MPa on its side flanges (15,16). The profile is welded to a cover (17) by single rows of weld dots (18). The side flanges have high strength zones (21,22) on both sides of the soft bands (20).

### TECHNICAL FIELD OF THE INVENTION

The invention relates to an elongate weld joint between a first steel sheet having a tensile strength above 1400 MPa and a second steel sheet wherein the first steel sheet has a soft zone with a tensile strength below 1100 MPa along the weld joint

### BACKGROUND OF THE INVENTION

WO 2011/071434 discloses a hat beam with a cover plate. The cover plate is welded to the side flanges of the hat beam. The hat beam is made by the press hardening process and has a tensile strength in excess of 1400 MPa. Portions of the length of its side flanges have high tensile strength and other portions have a tensile strength of less than 1100 MPa. According to conversion tables, a tensile strength of 1100 MPa corresponds to a hardness of 330 HV.

### OBJECT OF THE INVENTION AND BRIEF DESCRIPTION OF THE INVENTION

It is an object of the invention to strengthen a weld seam on a high strength sheet steel having a tensile strength exceeding 1400 MPa by reducing the risk of microscopic cracks in the region of the weld. This is important for example for vehicle components which are designed to take up collision energy by deformation since microscopic cracks will be initiators for cracks that would reduce the capability of absorbing energy. In particular it is important for a component which is composed of a hat beam of high strength steel with a cover welded to the high strength side flanges of the hat beam.

The object of invention is met when the soft zone has a width that is between ½ the width of the weld and 3 times the width of the weld and the first steel sheet has hard zones with a tensile strength above 1400 MPa on both sides of the weld joint. The invention is defined by the claims

### BRIEF DESCRIPTION OF THE DRAWING

FIG. 1 is a transparent isometric view of a short portion of the length of a hat profile with a cover.

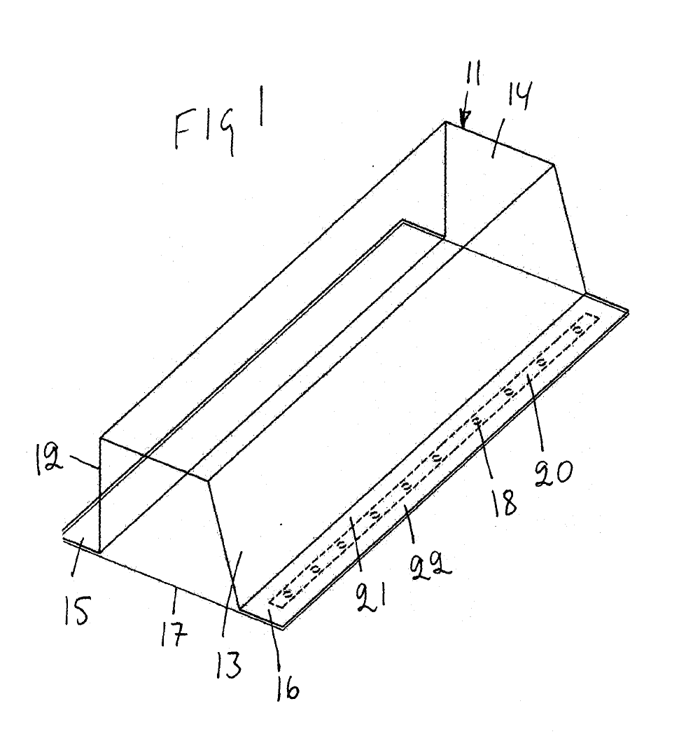

### DESCRIPTION OF THE ILLUSTRATED EXAMPLE OF THE INVENTION

A hat profile 11 has two sides 12,13 a central flange 14, and side flanges 15,16. A cover 17 is welded to the two side flanges by a line of dots 18. The hat profile is shaped and hardened from a flat sheet steel and it has a tensile strength exceeding 1400 MPa. The cover may be a cold rolled sheet having a lower strength. The hat profile 11 and its cover 17 form a beam with closed profile.

In vehicles, hat profiles with a cover are used as safety beams, for example the A, B and C pillars and door beams. Such beams are arranged to take up energy in side collisions by being plastically deformed. As much as possible of the steel should be plastically deformed before fracture and fracture initiators should be avoided.

Along the line of weld dots 18, each side flange has a narrow soft band 20 with a tensile strength less than 1100 MPa, for example 500-1000 MPa in which the weld dots are positioned. The side flanges have full strength on both sides of the soft band. The soft band has a width that is between half the width of the weld dots and three times the width of the weld dots. The lower strength and higher ductility of the soft band eliminates the formation of micro cracks in the HAZ (Heat Affected Zone) during the welding. Such cracks may be triggers for early fracture in a side collision.

The soft bands 20 reduce the risk of early fracture but they reduce the total strength of the side flanges comparatively little since they are narrow and the side flanges have high strength on both sides 21,22 of the soft bands 20. The cover 17 may have a strength exceeding 1400 MPa and have soft bands similar to the profile 11. The invention can also be applied to other high strength sheet steel items.

1. An elongate weld joint between a first sheet steel (11) having a tensile strength above 1400 MPa and a second sheet steel (17), wherein the first sheet steel has a soft zone (20) with a tensile strength below 1100 MPa around the weld joint, wherein the soft zone is a band (20) that has a width that is between ½ the width of the weld (18) and 3 times the width of the weld and the first sheet steel (11) has high strength zones (21,22) with a tensile strength above 1400 MPa on both sides of the soft band.

2. An elongate weld joint according to claim 1, wherein the weld comprises a single row of weld spots (18).

3. An elongate weld joint according to claim 1, wherein the weld (18) is a weld along a side flange (15,16) of a beam.

4. An elongate weld joint according to claim 3, wherein the weld (18) is a weld along a side flange (15,16) of the first steel sheet (11), which is in the form of a hat profile that has been given a closed profile by the second sheet steel (17) welded to the side flanges (15,16) of the hat profile.

5. A beam comprising a first sheet steel profile (11) comprising a top (14), two sides (12,13), and two side flanges (15,16), and a second steel sheet (17) joined by welds (18) to the side flanges to form a closed profile beam, wherein the first profile (11) has a tensile strength above 1400 MPa and soft zones (20) with a tensile strength below 11 MPa around the welds, wherein the soft zones are in the form of bands (20) that have a width that is between ½ the width of the weld (18) and 3 times the width of the weld and the first steel sheet has high strength zones with a tensile strength above 1400 MPa on both sides of the soft bands.

6. An elongate weld joint according to claim 2, wherein the weld (18) is a weld along a side flange (15,16) of a beam.

7. An elongate weld joint according to claim 6, wherein the weld (18) is a weld along a side flange (15,16) of the first steel sheet (11), which is in the form of a hat profile that has been given a closed profile by the second sheet steel (17) welded to the side flanges (15,16) of the hat profile.
